(19) United States
(12) Patent Application Publication
(10) Pub. No.: US 2005/0146535 A1
(43) Pub. Date: Jul. 7, 2005

(54) Systems and methods for updating display information

(75) Inventor: Kyung Fan Shin, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Pantech Co., Ltd.

(21) Appl. No.: 11/012,845

(22) Filed: Dec. 15, 2004

(30) Foreign Application Priority Data
Dec. 16, 2003 (KR) 10-2003-0092143

(51) Int. Cl. G01C 21/26

(52) U.S. Cl. 345/619

(57) ABSTRACT

The present invention relates to systems and methods for updating display information. More particularly, the present invention relates to systems and methods for updating display information that may reduce current consumption in mobile communication terminals by measuring display information, comparing new display information with existing display information, and updating display information only when there is a difference between the new display information and the existing display information. There is provided a system for updating display information comprising: a control unit for monitoring base station information, measuring display information, recording the display information, and updating display information if display interrupt is generated; a register comparing unit for storing the display information, comparing the display information each other, and instructing an interrupt unit to generate the display interrupt; and the interrupt unit for generating the display interrupt per the register comparing unit's instruction.

### CROSS-REFERENCE TO RELATED APPLICATION

The entire disclosure of Korean patent application No. 10-2003-0092143 filed on Dec. 16, 2003 including specification, claims, drawings and summary, is incorporated herein by reference in its entirety.

### BACKGROUND OF THE INVENTION

1. Field of the invention

The present invention relates to systems and methods for updating display information. More particularly, the present invention relates to systems and methods for updating display information that may reduce current consumption in mobile communication terminals by measuring display information, comparing new display information with existing display information, and updating display information only when there is a difference between the new display information and the existing display information.

2. Description of the Related Art

Generally, in Global System for Mobile Communication (GSM) system, in order to reduce current consumption, a mobile communication terminal operates generally in a sleep mode (a waiting mode) and periodically monitors base station information (Broadcast Control Channel, BCCH).

The mobile communication terminal measures display information, updates display information on screen such as liquid crystal display (LCD), and operates again in the sleep mode. The display information comprises battery information, analog to digital converter (ADC) information, received signal strength indication (RSSI) level information, time information, etc.

In the related art, a mobile communication terminal updates display information all the time without considering whether the display information is changed or not, whenever the mobile communication terminal monitors base station information. Further, because the mobile communication terminal updates display information all the time, the mobile communication terminal does not operate in a sleep mode when the mobile communication terminal should operate in the sleep mode. Thus, current consumption increases.

To solve the problems, the present invention reduces current consumption in mobile communication terminals, by measuring and comparing display information and by updating display information only when there occurs a change in display information.

### BRIEF SUMMARY OF THE INVENTION

Accordingly, the present invention has been made to solve the above-mentioned problems occurring in the related art, and an object of the present invention is to provide a system for updating display information comprising: a control unit for monitoring base station information, measuring display information, recording the display information, and updating display information on screen if display interrupt is generated; a register comparing unit for storing the display information, comparing the display information each other, and instructing an interrupt unit to generate the display interrupt; and the interrupt unit for generating the display interrupt per the register comparing unit's instruction.

And, in order to solve the above-mentioned problems, there is provided a method for updating display information comprising: monitoring base station information and measuring new display information; shifting existing display information stored in a first register area to a second register area, storing the existing display information in the second register area, and storing the new display information in the first register area; determining whether there is a difference between the new display information and the existing display information, by comparing the new display information and the existing display information; generating display interrupt per a register comparing unit's instruction to generate the display interrupt if there is a difference between the new display information and the existing display information; and updating display information by replacing the existing display information with the new display information per the display interrupt, the display interrupt being generated by an interrupt unit.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a system for updating display information according to one embodiment of the present invention;

FIG. 2 illustrates register comparing unit in FIG. 1; and

FIG. 3 illustrates a method for updating display information according to one embodiment of the present invention.

### DETAILED DESCRIPTION OF THE PREFERRED EMBODIMENTS

Hereinafter, a preferred embodiment of the present invention will be described with reference to the accompanying drawings.

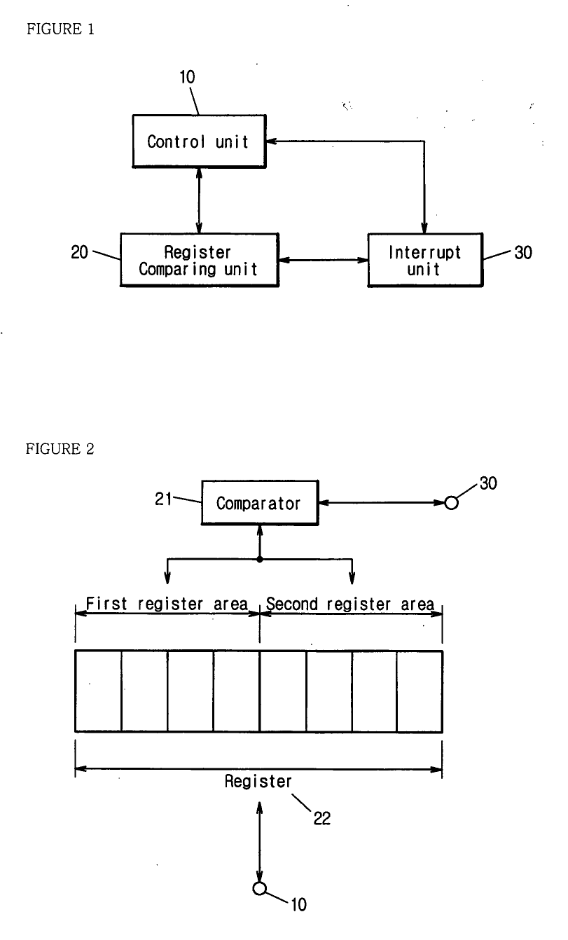

First, a system for updating display information according to one embodiment of the present invention will be described with reference to FIG. 1.

The system for updating display information according to one embodiment of the present invention comprises control unit 10, register comparing unit 20 and interrupt unit 30.

The control unit 10 monitors base station information and measures display information and records the display information, and when a display interrupt is generated, updates the display information.

The register comparing unit 20 stores the measured display information, compares them, and when there is a change in the display information, instructs the interrupt unit 30 to generate a display interrupt.

The interrupt unit 30 generates the display interrupt per the register comparing unit's instruction.

Hereinafter, the register comparing unit 20 will be described with reference to FIG. 2.

The register comparing unit 20 comprises a comparator 21 and a register 22.

The register 22 comprises a first register area for storing new display information, the first register area being consist of 4 words, and a second register area for storing existing display information, the second register area being consist of 4 words.

The comparator 21 compares the new display information with the existing display information, and when there is a difference between the new display information and the existing display information, instructs the interrupt unit to generate the display interrupt.

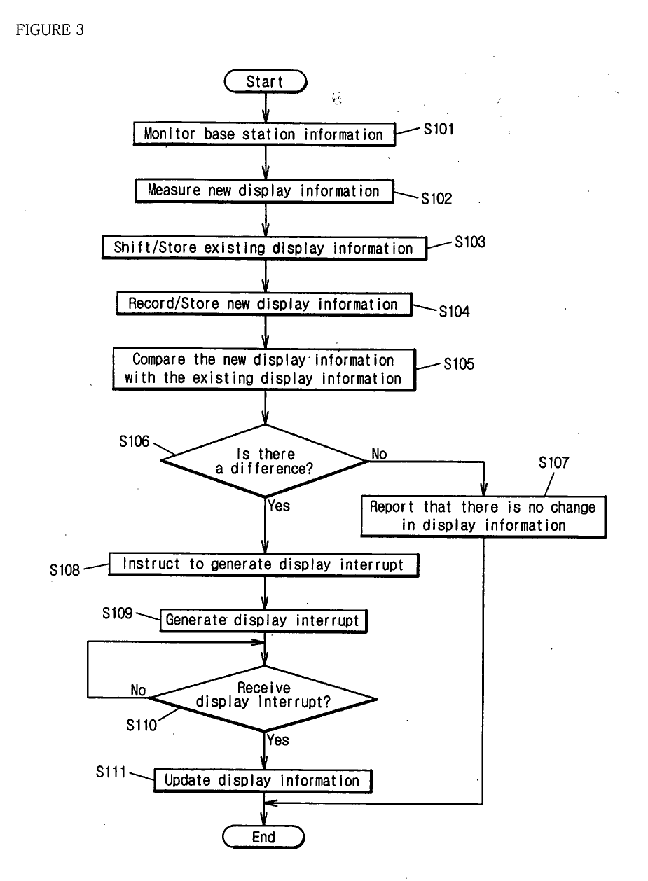

Hereinafter, a method for updating display information according to one embodiment of the present invention will be described with reference to FIG. 3.

FIG. 3 illustrates a method for updating display information according to one embodiment of the present invention.

The control unit 10 operates in the sleep mode and periodically monitors the base station information (S101).

And, the control unit 10 measures new display information from the monitored base station information (S102).

Then, the control unit 10 shifts the existing display information, which was stored in the first register area of the register 22 of the register comparing unit 20, to the second register area and stores the existing display information in the second register area (S103). The control unit 10, then, records and stores the measured new display information in the first register area (S104).

In other words, when the new display information is recorded in the first register area, the existing display information, stored in the first register area of the register 22 of the register comparing unit 20, is shifted to the second register area and stored in the second register area, before storing the new display information in the first register area.

Then, the comparator 21 of the register comparing unit 20 compares the new display information stored in the first register area with the existing display information stored in the second register area (S105) and determines whether there is a difference between the new display information and the existing display information (S106).

In case that there is no difference between the new display information and the existing display information according to result of the determination, the comparator 21 reports to the control unit 10 that there is no change in display information (S107) and the control unit 10 does not update display information on screen such as LCD.

On the other hand, in case that there is a difference between the new display information and the existing display information, the comparator 21 instructs the interrupt unit 30 to generate a display interrupt (S108).

According to the comparator's instruction, the interrupt unit 30 generates the display interrupt and transfers the display interrupt to the control unit 10 (S109).

Then, the control unit 10 receives the display interrupt from the interrupt unit 30 (S110) and updates display information on screen such as LCD by replacing the existing display information with the new display information (S1).

As described above, the present invention may reduce current consumption in mobile communication terminal, by measuring new display information, comparing existing display information with the new display information and updating display information on screen only when there is a difference between the new display information and the existing display information.

The foregoing embodiments are merely exemplary and are not to be construed as limiting the present invention. Many alternatives, modifications and variations will be apparent to those skilled in the art.

1. A system for updating display information comprising:
a control unit for monitoring base station information, measuring display information, recording the display information, and updating display information on screen if display interrupt is generated;
a register comparing unit for storing the display information, comparing the display information each other, and instructing an interrupt unit to generate the display interrupt; and
the interrupt unit for generating the display interrupt per the register comparing unit's instruction.

2. The system of claim 1, wherein the register comparing unit comprises:
a register comprising a first register area for storing new display information and a second register area for storing existing display information; and
a comparator for comparing the new display information and the existing display information, and instructing the interrupt unit to generate the display interrupt if there is a difference between the new display information and the existing display information.

3. A method for updating display information comprising:
monitoring base station information and measuring new display information;
shifting existing display information stored in a first register area to a second register area, storing the existing display information in the second register area, and storing the new display information in the first register area;
determining whether there is a difference between the new display information and the existing display information, by comparing the new display information and the existing display information;
generating display interrupt per a register comparing unit's instruction to generate the display interrupt if there is a difference between the new display information and the existing display information; and
updating display information by replacing the existing display information with the new display information per the display interrupt, the display interrupt being generated by an interrupt unit.

4. The method of claim 3, further comprising reporting to a control unit that there is no change in display information, if there is no difference between the existing display information and the new display information.
